(19) United States
(12) Patent Application Publication
(10) Pub. No.: US 2024/0265301 A1
(43) Pub. Date: Aug. 8, 2024

(54) COMPUTER SYSTEM AND INTERVENTION EFFECT PREDICTION METHOD

(71) Applicant: Hitachi, Ltd., Chiyoda-ku, Tokyo (JP)

(72) Inventors: Masahiro OGINO, Tokyo (JP); Peifei ZHU, Tokyo (JP); Zisheng LI, Tokyo (JP)

(21) Appl. No.: 18/290,194

(22) PCT Filed: May 9, 2022
(86) PCT No.: PCT/JP2022/019713

§ 371 Date: Nov. 10, 2023

(30) Foreign Application Priority Data
Jun. 25, 2021 (JP) 2021-105786

(51) Int. Cl. G06N 20/00

(52) U.S. Cl. CPC G06N 20/00

(57) ABSTRACT

A computer system manages a first model configured to generate a feature by mapping a vector including values of a plurality of factors representing a state of a person to a feature space and a second model configured to output predicted values of effects of a plurality of interventions on a person based on the feature, the first model and the second model being generated by machine learning. The first model maps a plurality of pieces of training data used in the machine learning to the feature space such that a difference in distribution of the plurality of pieces of training data in the feature space is reduced. The computer system receives input data including the values of the plurality of factors, generates the feature of the input data by inputting the input data into the first model, and calculates the predicted values of the effects of the plurality of interventions by inputting the feature of the input data into the second model.

### INCORPORATION BY REFERENCE

The present application claims priority from Japanese Patent Application No. 2021-105786 filed on Jun. 25, 2021, and contents of which are incorporated into the present application by reference.

### TECHNICAL FIELD

The present invention relates to a system and a method for predicting an effect of an intervention on a person.

### BACKGROUND ART

In various fields such as medical care and marketing, causal inference such as a randomized controlled trial is known as a method of estimating an effect of intervention (treatment, measures, and the like) performed on a person.

The randomized controlled trial requires a large-scale experiment and has a problem of high cost. Therefore, it is desired to develop a technique for performing the causal inference by using existing data. In response to the desire, a technique disclosed in PTL 1 is known.

PTL 1 discloses that “an intervention effect estimation system 10 includes: a group processing unit 24 that holds a group analysis result obtained by performing regression analysis on group data in which pieces of subject data of a plurality of persons are collected; and a personal processing unit 25 that sets, by using the group analysis result, an initial value of a regression coefficient in a regression model for a user as a regression model prepared for the user and an initial prior distribution used for Bayesian inference, and when the subject data of the user is acquired, updates the regression coefficient by Bayesian inference using likelihood of the subject data, and the personal processing unit 25 estimates an effect of intervention for the user based on the regression model for the user whose regression coefficient is updated by the personal processing unit 25”.

### CITATION LIST

### Patent Literature

PTL 1: JP2018-005707A

### Non Patent Literature

NPL 1: Fredrik D. Johansson, Uri Shalit, David Sontag, “Learning Representations for Counterfactual Inference”, 2016, [online], [searched on Jun. 14, 2021], Internet <URL: https://arxiv.org/abs/1605.03661v1>

### SUMMARY OF INVENTION

### Technical Problem

In the technique disclosed in PTL 1, a selection bias is not considered. In this regard, a technique disclosed in NPL 1 is known. In NPL 1, a group distribution bias, that is, a confounding bias is adjusted by using a discrepancy distance (for example, see FIG. 1 of NPL 1).

The discrepancy distance is given as a distance between two distributions, and there is a problem that it is difficult to apply the discrepancy distance to a plurality of interventions. In addition, the technique of NPL 1 has a problem in that an effect of reducing the confounding bias is small.

The invention solves the problems in the related art and provides a system and a method for predicting effects of a plurality of interventions to a person with high accuracy.

### Solution to Problem

A representative example of the invention disclosed in the present application is as follows. That is, a computer system for predicting effects of a plurality of interventions on a person is provided, and the computer system includes: at least one computer including a processor and a storage device connected to the processor, in which a first model configured to generate a feature by mapping a vector including values of a plurality of factors representing a state of the person to a feature space, and a second model configured to output, based on the feature, predicted values of the effects of the plurality of interventions on the person are managed, the first model and the second model being generated by machine learning, the first model maps a plurality of pieces of training data used in the machine learning to the feature space such that a difference in distribution of the plurality of pieces of training data in the feature space is reduced, and the computer system receives input data including the values of the plurality of factors, generates the feature of the input data by inputting the input data into the first model, and calculates the predicted values of the effects of the plurality of interventions by inputting the feature of the input data into the second model.

### Advantageous Effects of Invention

According to the invention, it is possible to predict the effects of the plurality of interventions on the person with high accuracy. Problems, configurations, and effects other than those described above will be clarified by description of the following embodiment.

### BRIEF DESCRIPTION OF DRAWINGS

FIG. 1 is a diagram showing a configuration example of a system according to Embodiment 1.

FIG. 2 is a diagram showing an example of a software configuration of a computer according to Embodiment 1.

FIG. 3 is a diagram showing an example of a training data DB according to Embodiment 1.

FIG. 4 is a diagram showing an example of a functional configuration of a training unit according to Embodiment 1.

FIG. 5 is a flowchart showing an example of training processing executed by the training unit according to Embodiment 1.

FIG. 6 is a flowchart showing an example of prediction processing executed by a prediction unit according to Embodiment 1.

FIG. 7 is a diagram showing an example of a prediction intervention result output by the prediction unit according to Embodiment 1.

FIG. 8 is a diagram showing an example of a prediction intervention result output by the prediction unit according to Embodiment 1.

### DESCRIPTION OF EMBODIMENTS

Hereinafter, an embodiment according to the invention will be described with reference to the drawings. However, the invention should not be construed as being limited to the description of the embodiment to be described below. Those skilled in the art could have easily understood that a specific configuration can be changed without departing from a spirit or a gist of the invention.

In configurations of the invention to be described below, the same or similar configurations or functions are denoted by the same reference numerals, and repeated descriptions thereof are omitted.

Notations of, for example, “first”, “second”, and “third” in the present specification are assigned to distinguish between components, and do not necessarily limit the number or order of those components.

To facilitate understanding of the invention, a position, a size, a shape, a range, and the like of each component shown in the drawings may not represent an actual position, size, shape, range, and the like. Therefore, the invention is not limited to positions, sizes, shapes, ranges, and the like shown in the drawings.

### Embodiment 1

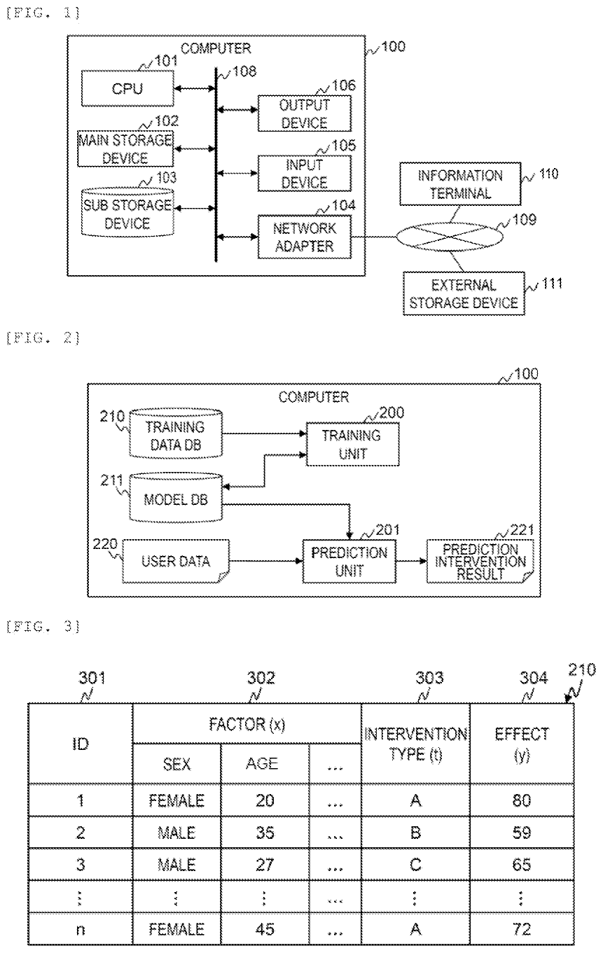

FIG. 1 is a diagram showing a configuration example of a system according to Embodiment 1.

The system includes a computer 100, an information terminal 110, and an external storage device 111. The computer 100, the information terminal 110, and the external storage device 111 are connected via a network 109. The network 109 is, for example, a local area network (LAN), a wide area network (WAN), or the like, and a connection method may be either wired or wireless.

The computer 100 executes training processing for generating a model for predicting an intervention effect, and predicts an intervention effect on user data (input data) by using the model. The computer 100 includes a CPU 101, a main storage device 102, a sub-storage device 103, a network adapter 104, an input device 105, and an output device 106. Hardware elements are connected via an internal bus 108.

The CPU 101 executes a program stored in the main storage device 102. The CPU 101 executes processing according to the program, thereby operating as a functional unit (module) that implements a specific function. In the following description, when the processing is described with the functional unit as a subject, it indicates that the CPU 101 executes a program for implementing the functional unit.

The main storage device 102 is a dynamic random access memory (DRAM) and stores the program to be executed by the CPU 101 and data used by the program. The main storage device 102 is also used as a work area.

The sub-storage device 103 is a hard disk drive (HDD), a solid state drive (SSD), or the like, and permanently stores data. The program and the data that are stored in the main storage device 102 may be stored in the sub-storage device 103. In this case, the CPU 101 reads the program and information from the sub-storage device 103 and loads the program and the information into the main storage device 102.

The network adapter 104 is an interface for connecting to an external device via the network 109.

The input device 105 is a keyboard, a mouse, a touch panel, or the like, and is a device for performing input to the computer 100.

The output device 106 is a display, a printer, or the like, and is a device for outputting a processing result of the computer 100.

A hardware configuration of the computer 100 is an example and is not limited thereto. For example, the computer 100 may not include the input device 105 and the output device 106.

The information terminal 110 is a terminal that performs various operations on the computer 100. For example, the information terminal 110 registers training data, registers a model, and inputs the user data. A hardware configuration of the information terminal 110 is the same as that of the computer 100.

The external storage device 111 stores various types of information. The external storage device 111 is, for example, an external HDD or an external storage system.

FIG. 2 is a diagram showing an example of a software configuration of the computer 100 according to Embodiment 1.

The computer 100 includes a training unit 200, a prediction unit 201, and further includes a training data DB 210, and a model DB 211. The training data DB 210 and the model DB 211 may be stored in the external storage device 111.

The training data DB 210 is a database in which the training data used for the training processing is stored. The training data DB 210 will be described with reference to FIG. 3. The model DB 211 is a database in which information on various models is stored.

The training unit 200 executes the training processing by using the training data stored in the training data DB 210 and the model stored in the model DB 211. The prediction unit 201 uses the models stored in the model DB 211 to predict an intervention effect on user data 220 and output the predicted intervention effect as a prediction intervention result 221.

FIG. 3 is a diagram showing an example of the training data DB 210 according to Embodiment 1.

The training data DB 210 stores entries including an ID 301, a factor 302, an intervention type 303, and an effect 304. One entry corresponds to one piece of training data. Fields included in the entries are not limited to those described above. Any of the fields described above may not be included, and other fields may be included.

The ID 301 is a field for storing identification information for uniquely identifying the training data. Identification numbers are stored in the ID 301 according to the present embodiment.

The factor 302 is a field for storing a value of a factor such as a state and a characteristic of a person who receives the intervention. The factor includes, for example, age, sex, and height. In the present embodiment, a type and the number of factors included in the factor 302 are not limited.

The intervention type 303 is a field for storing information indicating a type of the intervention performed on the person corresponding to the training data.

The effect 304 is a field for storing a value of an index indicating an effect due to the intervention.

The user data 220 is data obtained by removing the intervention type 303 and the effect 304 from the training data.

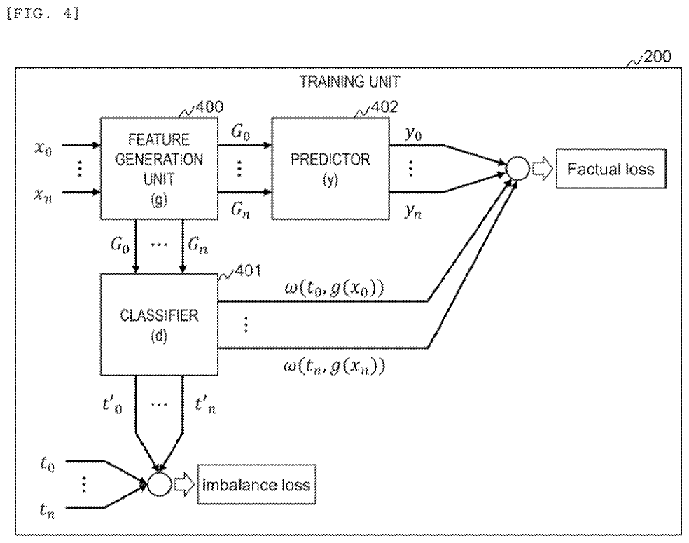

FIG. 4 is a diagram showing an example of a functional configuration of the training unit 200 according to Embodiment 1.

The training unit 200 includes a feature generation unit 400, a classifier 401, and a predictor 402.

The feature generation unit 400 generates a feature Gᵢ by mapping a factor xᵢ to a feature space of any dimension. The feature generation unit 400 is defined as a model such as a neural network. Here, the factor xᵢ is an n-dimensional vector representing a factor of a person whose identification information is i. The factor xᵢ corresponds to the factor 302 of the training data, and n represents the number of fields of the factor 302.

The classifier 401 classifies an intervention t′ᵢ performed on the person from the feature Gᵢ. The classifier 401 is defined as a model such as a neural network. Here, the intervention t′ᵢ is a k-dimensional vector representing a predicted value of an intervention performed on the person whose identification information is i. K represents a type of the intervention.

The training unit 200 uses the interventions t′ᵢ and interventions tᵢ of a plurality of persons to calculate an imbalance loss function for evaluating an error between the intervention t′ᵢ and the intervention tᵢ. Here, the intervention tᵢ represents the intervention performed on the person whose identification information is i. The intervention tᵢ is a numerical value j corresponding to the type of the intervention stored in the intervention type 303 of the training data. For example, when the type of the intervention is “A”, the numerical value j is “1”, and when the type of intervention is “B”, the numerical value j is “2”.

The imbalance loss function is defined by Formula (1).

$$[ Math 1 ]$$

$${\sum }_{i = 0}^{n} α log d ( g ( {x}_{i} ) , {t}_{i} ) \qquad ( 1 )$$

α represents a constant larger than 0. g(xᵢ) represents the feature Gᵢ. d(g(xᵢ), tᵢ) represents an output of the classifier 401, that is, the intervention t′ᵢ.

The predictor 402 calculates a prediction intervention effect yᵢ based on the feature Gᵢ. The predictor 402 is defined as a model such as a neural network. Here, the prediction intervention effect yᵢ is a k-dimensional vector representing prediction of an effect of each intervention of the person whose identification information is i.

The training unit 200 calculates a weight ω(tᵢ=j, g(xᵢ)) by using the feature Gᵢ of each person. Here, g(xᵢ) represents the feature Gᵢ.

The weight ω(tᵢ=j, g(xᵢ)) is defined by Formula (2).

$$[ Math 2 ]$$

$$ω ( {t}_{i} = j , g ( {x}_{i} ) ) = 1 + \frac{Pr ( j )}{1 - Pr ( j )} \cdot \frac{1 - d ( g ( {x}_{i} ) , {t}_{i} = j )}{d ( g ( {x}_{i} ) , {t}_{i} = j )} \qquad ( 2 )$$

Pr(j) represents a probability value when the intervention tᵢ is j in an entire data set.

In addition, the training unit 200 calculates a factual loss function for evaluating an error between an effect y^{F}ᵢ and the prediction intervention effect yᵢ by using the prediction intervention effects yᵢ of the plurality of persons and the weight ω(tᵢ=j, g(xᵢ)). Here, the effect y^{F}ᵢ represents an effect of the intervention performed on the person whose identification information is i. The effect y^{F}ᵢ is a value of the effect 304.

The factual loss function is defined by Formula (3).

$$[ Math 3 ]$$

$${\sum }_{i = 0}^{n} ω ( {t}_{i} = j , g ( {x}_{i} ) ) \vert y ( g ( {x}_{i} ) , {t}_{i} ) - {y}_{i}^{F} \vert \qquad ( 3 )$$

The training unit 200 updates the feature generation unit 400, the classifier 401, and the predictor 402 based on a loss function defined based on the factual loss function and the imbalance loss function as shown in Formula (4). By multiplying the weight ω(tᵢ=j, g(xᵢ)), it is possible to reduce an influence of a confounder.

$$[ Math 4 ]$$

$${min}_{g , y} \frac{1}{n} {\sum }_{i = 0}^{n} [ ω ( {t}_{i} = j , g ( {x}_{i} ) ) \vert y ( g ( {x}_{i} ) , {t}_{i} ) - {y}_{i}^{F} \vert + α log d ( g ( {x}_{i} ) , {t}_{i} ) ] \qquad ( 4 )$$

In the present embodiment, the feature generation unit 400 and the classifier 401 perform training using a generative adversarial network (GAN). The feature generation unit 400 is updated such that the classifier 401 cannot identify, based on the feature, the type of the intervention performed on the person. The update means that a difference (bias), due to a difference in intervention, in the distribution of g(xᵢ) in a space (feature space) of a mapping destination of the factor xᵢ is adjusted to be small. Therefore, the feature generated by the feature generation unit 400 is a feature from which the influence of the confounder is excluded.

By adjusting the difference in distribution of g(xᵢ) in the feature space to be small by using the GAN, the selection bias can be reduced, and the confounding bias can be made lower than that of NPL 1. In addition, by using the factual loss function obtained by multiplying the weight reflecting the feature of the person, the confounding bias can be further eliminated. Therefore, the intervention effect can be accurately predicted.

The training may be performed using the loss function that does not include the weight.

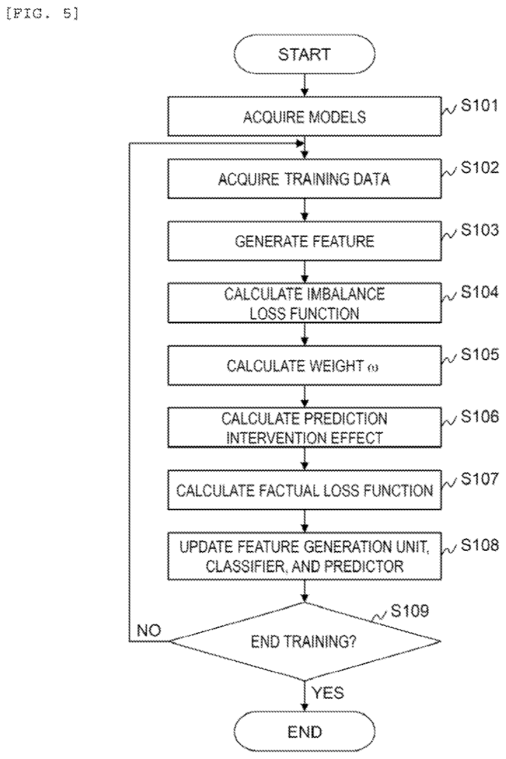

FIG. 5 is a flowchart showing an example of the training processing executed by the training unit 200 according to Embodiment 1.

When a training execution instruction is received via the information terminal 110 or the input device 105, the training unit 200 executes the training processing.

The training unit 200 acquires the models of the feature generation unit 400, the classifier 401, and the predictor 402 from the model DB 211 (step S101).

The training unit 200 acquires the training data from the training data DB 210 (step S102). Here, it is assumed that a training data set including a plurality of pieces of training data is acquired.

The training unit 200 generates the feature g(xᵢ) by inputting the factor xᵢ of each training data of the training data set to the feature generation unit 400 (step S103).

The training unit 200 calculates the imbalance loss function by using the intervention tᵢ obtained by inputting the feature g(xᵢ) to the classifier 401 and the intervention t′ᵢ of the person (step S104).

The training unit 200 calculates the weight ω(tᵢ, g(xᵢ)) by using the feature g(xᵢ) (step S105).

The training unit 200 calculates the prediction intervention effect yᵢ by inputting the feature g(xᵢ) to the predictor 402 (step S106).

The training unit 200 calculates the factual loss function by using the weight ω(tᵢ, g(xᵢ)), the effect 304 of the training data, and the prediction intervention effect yᵢ (step S107).

The training unit 200 calculates the loss function in Formula (4) and updates the feature generation unit 400, the classifier 401, and the predictor 402 by using the function (step S108). At this time, the training unit 200 stores an updated result in the model DB 211.

The training unit 200 determines whether to end the training (step S109). For example, if the number of updates is larger than a threshold, the training unit 200 determines to end the training. In addition, if prediction accuracy of the prediction intervention effect of the user data 220 for evaluation is larger than a threshold, the training unit 200 determines to end the training.

When it is determined that the training is not to be ended, the training unit 200 returns to step S102 and executes the same processing.

When it is determined to end the training, the training unit 200 ends the training processing.

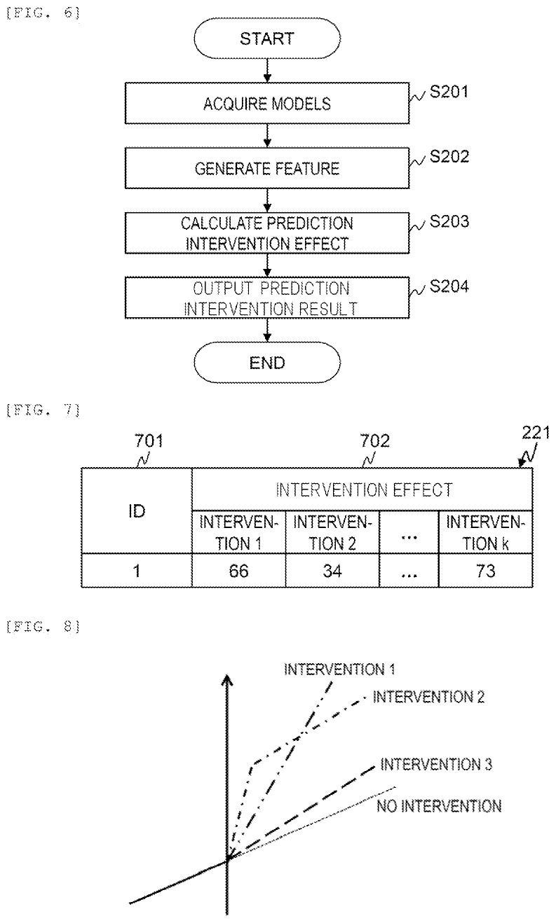

FIG. 6 is a flowchart showing an example of prediction processing executed by the prediction unit 201 according to Embodiment 1. FIGS. 7 and 8 are diagrams showing examples of the prediction intervention result 221 outputted by the prediction unit 201 according to Embodiment 1.

When the prediction unit 201 receives a prediction execution instruction including the user data 220 via the information terminal 110 or the input device 105, the prediction unit 201 executes the prediction processing.

The prediction unit 201 acquires the models of the feature generation unit 400 and the predictor 402 from the model DB 211 (step S201).

The prediction unit 201 generates the feature g(xᵢ) by inputting the factor xᵢ of the user data 220 to the feature generation unit 400 (step S202).

The prediction unit 201 calculates the prediction intervention effect yᵢ by inputting the feature g(xᵢ) to the predictor 402 (step S203).

The prediction unit 201 generates and outputs the prediction intervention result 221 including the prediction intervention effect yᵢ (step S204). Thereafter, the prediction unit 201 ends the prediction processing.

The prediction intervention result 221 includes an ID 701 and an intervention effect 702. The ID 701 is a field for storing user identification information included in the user data. The intervention effect 702 is a field group for storing a predicted value of the effect for each intervention.

By inputting time series data of the user data 220 to the prediction unit 201, time series data of the predicted value of the intervention effect as shown in FIG. 8 can be output.

The invention is not limited to the above-described embodiment and includes various modifications. For example, the above-described embodiment is described in detail for easy understanding of the invention, and the invention is not necessarily limited to those including all the configurations described above. A part of the configuration of each embodiment may be added to, deleted from, and replaced with another configuration.

A part or all of the configurations, functions, processing units, processing methods, or the like described above may be implemented by hardware such as through design using an integrated circuit. In addition, the invention can also be implemented by a program code of software for implementing functions of the embodiment. In this case, a storage medium recording the program code is provided to a computer, and a processor in the computer reads out the program code stored in the storage medium. In this case, the program code itself read from the storage medium implements the functions of the above-described embodiment, and the program code itself and the storage medium storing the program code constitute the invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

Further, the program code that implements the functions described in the present embodiment can be implemented in a wide range of programs or script languages such as Assembler, C/C++, Perl, Shell, PHP, Python, and Java.

Further, the program code of the software that implements the functions of the embodiment may be stored in a storage device such as a hard disk or a memory of a computer or a storage medium such as a CD-RW or a CD-R by being delivered via a network, and a processor in the computer may read out and execute the program code stored in the storage device or the storage medium.

In the embodiment described above, control lines and information lines are considered to be necessary for description, and all control lines and information lines are not necessarily shown in the product. All the components may be connected.

1. A computer system for predicting effects of a plurality of interventions on a person, the computer system comprising:
at least one computer including a processor and a storage device connected to the processor, wherein
a first model configured to generate a feature by mapping a vector including values of a plurality of factors representing a state of the person to a feature space, and a second model configured to output, based on the feature, predicted values of the effects of the plurality of interventions on the person are managed, the first model and the second model being generated by machine learning,
the first model maps a plurality of pieces of training data used in the machine learning to the feature space such that a difference in distribution of the plurality of pieces of training data in the feature space is reduced, and
the computer system
receives input data including the values of the plurality of factors,
generates the feature of the input data by inputting the input data into the first model, and
calculates the predicted values of the effects of the plurality of interventions by inputting the feature of the input data into the second model.

2. The computer system according to claim 1, wherein
a third model configured to identify, based on the feature, a type of an intervention received by the person is managed, and
the machine learning is executed,
the machine learning including:
processing of receiving training data including identification information on the person, the values of the plurality of factors of the person, a type of an intervention received by the person, and an effect value of the intervention;
processing of calculating the feature of the training data by inputting the training data into the first model;
processing of calculating the predicted values of the effects of the plurality of interventions by inputting the feature of the training data into the second model;
processing of calculating a loss function based on the type of the intervention obtained by inputting the feature of the training data into the third model, the type of the intervention included in the training data, the predicted values of the effects of the plurality of interventions, and the effect value included in the training data; and
processing of updating the first model, the second model, and the third model by using the loss function.

3. The computer system according to claim 2, wherein
the machine learning includes:
processing of calculating a weight based on the feature of the training data; and
processing of calculating the loss function based on the type of the intervention obtained by inputting the feature of the training data into the third model, the type of the intervention included in the training data, the predicted values of the effects of the plurality of interventions, the effect value included in the training data, and the weight.

4. An intervention effect prediction method of predicting effects of a plurality of interventions on a person executed by a computer system,
the computer system
including at least one computer including a processor and a storage device connected to the processor, and
managing a first model configured to generate a feature by mapping a vector including values of a plurality of factors representing a state of the person to a feature space and a second model configured to output, based on the feature, predicted values of the effects of the plurality of interventions on the person, the first model and the second model being generated by machine learning,
mapping, by the first model, a plurality of pieces of training data used in the machine learning to the feature space such that a difference in distribution of the plurality of pieces of training data in the feature space is reduced, and
receiving input data including the values of the plurality of factors,
the intervention effect prediction method comprising:
a step of generating, by the at least one computer, the feature of the input data by inputting the input data into the first model; and
a step of calculating, by the at least one computer, the predicted values of the effects of the plurality of interventions by inputting the feature of the input data into the second model.

5. The intervention effect prediction method according to claim 4, wherein
the computer system manages a third model configured to identify, based on the feature, a type of an intervention received by the person, and
the intervention effect prediction method includes:
a first step of receiving, by the at least one computer, training data including identification information on the person, the values of the plurality of factors of the person, a type of an intervention received by the person, and an effect value of the intervention;
a second step of calculating, by the at least one computer, the feature of the training data by inputting the training data into the first model;
a third step of calculating, by the at least one computer, the predicted values of the effects of the plurality of interventions by inputting the feature of the training data into the second model;
a fourth step of calculating, by the at least one computer, a loss function based on the type of the intervention obtained by inputting the feature of the training data into the third model, the type of the intervention included in the training data, the predicted values of the effects of the plurality of interventions, and the effect value included in the training data; and
a fifth step of updating, by the at least one computer, the first model, the second model, and the third model by using the loss function.

6. The intervention effect prediction method according to claim 5, wherein
the second step includes a step of calculating, by the at least one computer, a weight based on the feature of the training data, and
the fourth step includes a step of calculating, by the at least one computer, the loss function based on the type of the intervention obtained by inputting the feature of the training data into the third model, the type of the intervention included in the training data, the predicted values of the effects of the plurality of interventions, the effect value included in the training data, and the weight.
